(19) United States
(12) Patent Application Publication
(10) Pub. No.: US 2003/0189566 A1
(43) Pub. Date: Oct. 9, 2003

(54) Three-dimensional modeling system

(76) Inventors: Naoki Fuki, Okazaki-City (JP); Koichi Suzumura, Obu-City (JP); Masayuki Tanase, Toyota-City (JP); Toshio Tanaka, Anjyo-City (JP); Daisuke Matsugashita, Nagoya-City (JP); Toshinori Suyama, Kariya-City (JP)

Correspondence Address: NIXON & VANDERHYE, PC, 1100 N GLEBE ROAD, 8TH FLOOR, ARLINGTON, VA, 22201-4714, US

(21) Appl. No.: 10/406,214

(22) Filed: Apr. 4, 2003

(30) Foreign Application Priority Data
Apr. 5, 2002 (JP) 2002-103928

(51) Int. Cl. G06T 15/00

(52) U.S. Cl. 345/419

(57) ABSTRACT

A three-dimensional modeling system comprised of a CAD apparatus provided with an input unit comprised of a keyboard etc., a computer forming the core of the system, and a display unit and a server provided with a three-dimensional model database, a characterizing quantity extraction database, a design rule database, and a shape sample database, wherein the computer recognizes a three-dimensional model as a whole without using attribute information and identifies the corresponding part and also extracts characterizing quantities included in the three-dimensional model for the identified part, applies design rules in the design rule database to the characterizing quantities extracted, and judges if the three-dimensional model complies with the design rules.

### BACKGROUND OF THE INVENTION

1. Field of the Invention

The present invention relates to a computer aided three-dimensional modeling system for designing a three-dimensional model using a knowledge base.

2. Description of the Related Art

As related art of this type, a CAD system has been proposed which stores knowledge information such as design rules as a knowledge base and designs a three-dimensional model using that knowledge base. This system is known as a “knowledge based engineering” (KBE) system. With this KBE system, at the design stage, a designer can apply this knowledge to a prepared three-dimensional model without spending time looking up various standards etc.

For example, the CAD system of Japanese Unexamined Patent Publication (Kokai) No. 11-296566 is provided with a knowledge base management apparatus for managing one or more knowledge bases and a shape operation apparatus for modifying the data of shape components. Further, the knowledge base management apparatus displays a list of the knowledge bases relating to a shape component of a part selected and searches for shape constraining rules relating to the selected shape component when one or more knowledge bases are selected from the list of knowledge bases. The shape operation apparatus performs a shape inspection by comparing the found shape constraint rules with the current data of the shape component and modifies the data of the shape component automatically when the shape constraint rules are violated.

With the above CAD system, in designing a three-dimensional model of a part, the part is broken down into shape components to define the same and each of the shape components is automatically modified to efficiently design various parts.

In the above system, however, each part was defined by shape components and each shape component was given attribute information in advance such as the boundaries of the shape component and name of the shape component. Further, knowledge bases are being constructed as libraries of shape components including such attribute information. Therefore, the desired performance is achieved only when assuming the existence of the attribute information. Specifically, if the three-dimensional model of a part is not given a value, name, parameters, or other attribute information or if an attribute information cannot be read by the current CAD system, functions such as shape modification cannot be performed on the three-dimensional model.

In this case, even when designing a three-dimensional model etc. by using knowledge information in the knowledge base, the problem arises that the system is constrained by the presence of the attribute information. Therefore, the inconvenience arises that design rules and other knowledge cannot be suitably used and demands for streamlining design work etc. cannot be sufficiently met.

### SUMMARY OF THE INVENTION

An object of the present invention is to provide a three-dimensional modeling system able to suitably analyze a three-dimensional model without regard as to its attribute information and in turn able to streamline design work etc.

To attain the above object, as explained later with reference to the drawings, there is provided a three-dimensional modeling system comprised of a CAD apparatus (10) provided with an input unit (11) comprised of a keyboard etc., a computer body (12) forming the core of the system, and a display unit (13) and a server (20) provided with a three-dimensional model database (21), a characterizing quantity extraction database (22), a design rule database (23), and a shape sample database (24), wherein the computer (12) recognizes a three-dimensional model as a whole without using attribute information and identifies the corresponding part and also extracts characterizing quantities included in the three-dimensional model for the identified part, applies design rules in the design rule database (23) to the characterizing quantities extracted, and judges if the three-dimensional model complies with the design rules. Due to this, it is possible to suitably analyze a three-dimensional model without relying on attribute information and in turn streamline design work.

### BRIEF DESCRIPTION OF THE DRAWINGS

These and other objects and features of the present invention will become clearer from the following description of the preferred embodiments given with reference to the attached drawings, wherein:

FIG. 1 is a view of the general configuration of a CAD system according to an embodiment of the present invention;

FIG. 2 is a view of an example of a three-dimensional model;

FIG. 3 is a flow chart of the flow for acquisition of design rules; and

FIG. 4 is a flow chart of the flow for application of design rules.

### DESCRIPTION OF THE PREFERRED EMBODIMENTS

Preferred embodiments of the present invention will be described in detail below while referring to the attached figures.

First, the concepts of the present invention will be described

According to a first aspect of the present invention, the knowledge base defines in advance characterizing quantities of a geometric shape forming a three-dimensional model and prescribes knowledge information individually for those characterizing quantities. Further, a characterizing quantity extracting means extracts characterizing quantities included in the three-dimensional model of the corresponding part. A knowledge base applying means applies the knowledge information of the knowledge base to the characterizing quantities extracted and judges if the three-dimensional model complies with that knowledge information.

In short, a three-dimensional model may be considered to have a large number of characterizing quantities of geometric shape. Knowledge information may be prescribed in units of those characterizing quantities. Similarly, characterizing quantities of a three-dimensional model is extracted and knowledge information is applied in units of the characterizing quantities. In this case, even if the three-dimensional model is not given attribute information (value, name, parameters, etc.) or is given unreadable attribute information, the three-dimensional model can be analyzed from the characterizing quantities. That is, when analyzing a three-dimensional model, attribute information becomes unnecessary. As a result, it becomes possible to suitably analyze a three-dimensional model without relying on the attribute information of the model and in turn to streamline design work etc.

In this specification, a “characterizing quantity of geometric shape” differs from attribute information of a value, name, parameters etc. and means characterizing shape information comprised of only fundamental components such as spatial coordinates, points, lines, and surfaces of a three-dimensional model. Further, a “characterizing quantity” includes in its broader sense even characterizing ancillary items relating to shape. Further, “knowledge information” means various information for preparing a model relating to the product design such as design dimensions, tolerance, design knowhow, examples of failures, cost information, material information, etc.

According to a second aspect of the present invention, in the same way as the first aspect, the knowledge base defines in advance characterizing quantities of a geometric shape forming a three-dimensional model and prescribes knowledge information individually for those characterizing quantities. Further, a part identifying means recognizes a three-dimensional model as a whole without using attribute information and identifies the corresponding part. Further, a characterizing quantity extracting means extracts characterizing quantities included in the three-dimensional model for the identified part. A knowledge base applying means applies the knowledge information of the knowledge base to the characterizing quantities extracted and judges if the three-dimensional model complies with that knowledge.

In the second aspect as well, in the same way as the first aspect, it becomes possible to suitably analyze a three-dimensional model without relying on the attribute information of the model and in turn to streamline the design work etc. Further, in the second aspect of the invention, there is no need for attribute information even when identifying the part. Therefore, even if the part of the three-dimensional model is not given a name etc., the part of the three-dimensional model, read each time, can be identified. That is, so long as the three-dimensional model is comprised of a solid, wire frame, surface data, point group data, etc. having shape, the above series of analysis work can be realized.

As the characterizing quantity extracting means, either of a first embodiment or second embodiment can be applied. In the first embodiment, the characterizing quantities are extracted from at least point information present on the three-dimensional model, while in the second embodiment, the characterizing quantities are extracted from information of points, lines, surfaces, or solids present on the three-dimensional model or a combination of the same. In such a case, it becomes possible to analyze the shape of the three-dimensional model using just shape information.

In the second aspect of the present invention, as in a third embodiment, the part identifying means can obtain shape data of the three-dimensional model by a wavelet transform, compare the obtained shape data and sample values preset for different parts, and identify the part of the three-dimensional model from the results of the comparison. Due to this, a part can be easily and reliably identified.

In a fourth embodiment, the knowledge base applying means obtains knowledge information from the knowledge base for extracted characterizing quantities and applies that knowledge information individually to the three-dimensional model. Due to this, even when the knowledge base includes a tremendous amount of knowledge information, only the necessary matters can be quickly taken out, the time for application of the knowledge base can be shortened, and in turn the processing when judging compliance of the three-dimensional model can be speeded up.

In a fifth embodiment, when the knowledge base applying means judges that the three-dimensional model does not comply with the knowledge information in the knowledge base, it displays or outputs the specific content of the noncomplying location and warning information. Due to this, it is possible to easily deal with noncomplying locations of a three-dimensional model.

In a sixth embodiment, when the knowledge base applying means judges that the three-dimensional model complies with the knowledge information in the knowledge base, it displays or outputs the content of the suitable knowledge information changed in stages in accordance with the level of knowledge of the worker at each instance. That is, according to this embodiment, when the three-dimensional model is judged suitable (without error), the content of the display or output of the suitable knowledge information differs between a skilled worker and a worker with a lower level of knowledge. The lower the level, the greater the content displayed or output. Due to this, a worker with a low level of knowledge can obtain more knowledge from the display or output.

In a seventh embodiment, the apparatus starts up another shape analysis software, if necessary, regarding the knowledge information to be applied on each occasion and judges the compliance of the three-dimensional model with reference to the results of analysis of that shape analysis software. In this case, more knowledge information can be applied to the three-dimensional model.

Next, the present invention will be explained with reference to the drawings when the present invention is adopted specifically to a three-dimensional CAD system.

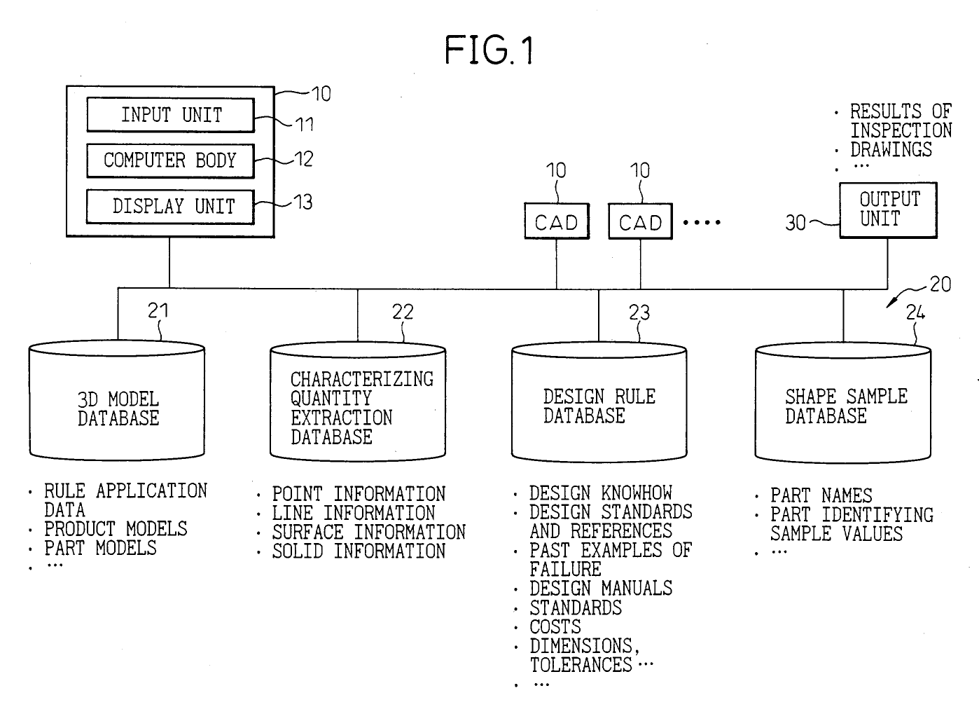

FIG. 1 is a block diagram of the general configuration of the CAD system. In FIG. 1, a plurality of CAD apparatuses (computer terminals) 10 and a server 20 are connected to communicate with each other by a LAN or other network means. Each of the CAD apparatuses 10 has substantially the same configuration, i.e., is comprised of an input unit 11 comprised of a keyboard, mouse etc., a computer body (computer part) 12 forming the core of the system and a display unit (screen) 13. The computer 12 is, as well known, comprised of a logic processing circuit provided with a CPU, memory, etc. and has various design support functions for automatic design of a three-dimensional model. Further, the computer 12 is loaded with so-called “computer aided engineering” (CAE) shape analysis software.

The display unit 13 displays the three-dimensional model designed by the computer 12 and also various messages at the design stage or the design inspection stage. A printer or other output unit 30 is also connected to the network.

The server 20 is equivalent to a storage unit for storing various databases. Specifically, it has the following databases:

(1) a three-dimensional model database 21 storing data to which the rules are applied, that is, three-dimensional models of products and parts

(2) a characterizing quantity extracting database 22 storing point information, line information, surface information, and solid information required for shape analysis of a three-dimensional model

(3) a design rule database 23 storing various design rules (that is, knowledge information) such as design knowhow, design standards and references, past examples of failure, design manuals, standards, costs, dimensions, tolerances, etc.

(4) a shape sample database 24 storing shape sample information such as part names, part identifying sample values, etc.

Here, a three-dimensional model may be considered to have a large number of characterizing quantities of geometric shape. The design rule database 23 prescribes various types of design rules in units of those characterizing quantities. The design rule database 23 corresponds to the “knowledge base” recited in the claims.

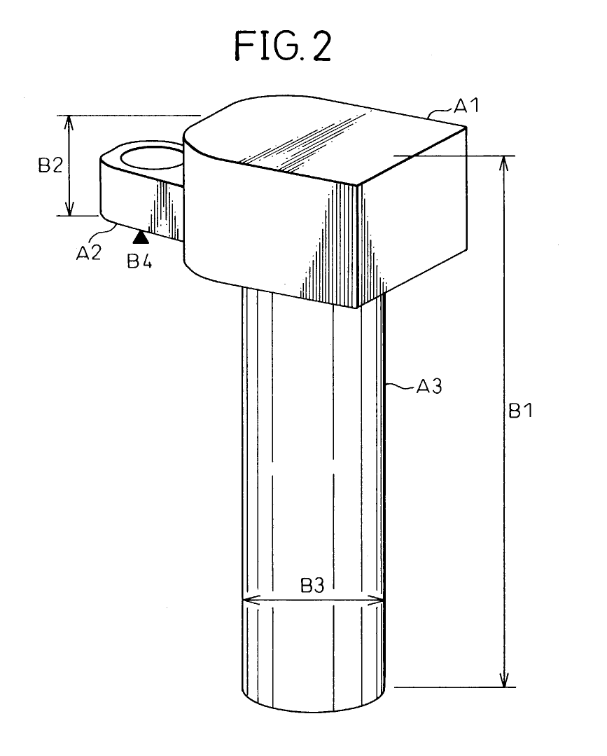

A specific example will be explained next using the three-dimensional model shown in FIG. 2. The three-dimensional model illustrated shows one part, that is, a “case”, of a “stick coil (coil assembly for engine ignition)”. The case is comprised of shape components of a head A1, flange A2, and cylindrical part A3. In the case of a conventional device (for example, described in Japanese Unexamined Patent Publication (Kokai) No. 11-296566), attribute information, including the names of the “head A1”, “flange A2”, and “cylindrical part A3”, was given to the shape components and the three-dimensional model to be designed for each shape component. Further, at the time of design, analysis, etc. by the CAD apparatus, the necessary information was suitably called up from the shape component library. In that conventional apparatus, the shape components and attribute information were inseparable. In the present embodiment, however, there is no routine for recognizing shape components. Characterizing quantities of geometric shape, which is unrelated with the attribute information, are extracted for analysis of the part.

That is, characterizing quantities of the three-dimensional model are extracted from all or part of the point, line, surface, and solid information of the three-dimensional model. The characterizing quantities in the illustrated case part (in FIG. 2) are, for example, B1 (case total length), B2 (flat bottom surface position), B3 (cylindrical part outside diameter), and B4 (resonance frequency when constraining flange). Design rules are individually applied to these characterizing quantities (B1 to B4).

The CAD system of the above configuration has the function of reading out a three-dimensional model in the three-dimensional model database 31 and automatically issuing a warning when its shape is unsuitable. The routine for this automatic warning will be explained below. In this case, the flow of processing of the CAD apparatus 10 (computer body 12) may be roughly divided into:

(a) processing for recognizing a three-dimensional model as a whole and identifying the corresponding part (part identifying means)

(b) processing for extracting characterizing quantities included in the three-dimensional model (characterizing quantity extracting means)

(c) processing for applying design rules in the design rule database 23 to the extracted characterizing quantities (knowledge base applying means)

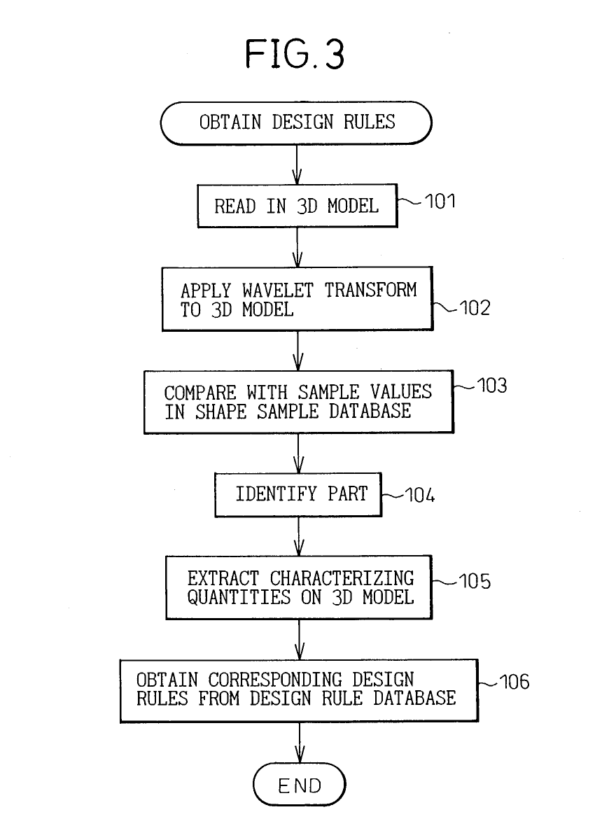

FIG. 3 is a flow chart of the processing routine from reading in a three-dimensional model to obtaining corresponding design rules. This processing is executed by the computer 12 based on an input operation by a worker (designer) to the input unit 11.

In FIG. 3, first, at step 101, a three-dimensional model stored in the three-dimensional model database 21 is read. In the example of FIG. 2, the illustrated three-dimensional model is read out. In this case, the read three-dimensional model need not be given attribute information such as a value, name, or parameters. It is possible to read a three-dimensional model from any CAD apparatus (or CAD system) or read one converted into data by a translator etc. Further, the read three-dimensional model may be not only a completed part or product, but also one being created in the modeling stage.

Next, at steps 102 to 104, the part of the read three-dimensional model is identified. In the present embodiment, a wavelet transform is used to automatically recognize the shape of the three-dimensional model and identify the part from the results. Specifically, the primary axes (X-axis, Y-axis, and Z-axis) of the three-dimensional model are aligned and voxel processing performed, then a wavelet transform applied (step 102). Due to this, the waveform data expressing the characteristics of the three-dimensional model is obtained. This waveform data is compared with part identifying sample value of each part stored in advance in the shape sample database 24 (step 103) and the part identified from the results of the comparison (step 104). In the example of FIG. 2, the part is identified as being a “case”.

At step 105, the characterizing quantities present on the model for the read three-dimensional model are extracted. At this time, the point information, line information, surface information, and solid information in the characterizing quantity extracting database 22 are used for extracting characterizing quantities. In the example of FIG. 2, as the characterizing quantities, B1 (case total length), B2 (flat bottom surface position), B3 (cylindrical part outside diameter), and B4 (resonance frequency when constraining flange) are extracted.

In actuality, line information is learned from the coordinate data of two points on the three-dimensional model, while surface information is learned from the coordinate data of three or more points. In addition, solid information is learned from the coordinate data of a large number of points. The characterizing quantities of the geometric shape, that is, the items of the above B1 to B4 etc., are extracted from the above information.

Next, at step 106, the corresponding design rules for the extracted characterizing quantities are obtained from the design rule database 23. Explaining the rules for the characterizing quantities B1 to B4 of the example of FIG. 2,

B1 (case total length) should be smaller than or equal to 100 mm

B2 (flat bottom surface position) should be smaller than or equal to 50 mm from top end face of case and smaller than or equal to 150 mm from bottom end face of case

B3 (cylindrical part outside diameter) should be smaller than or equal to φ25

B4 (resonance frequency when constraining flange) should be at least first order vibration frequency of engine side (for example, 500 Hz).

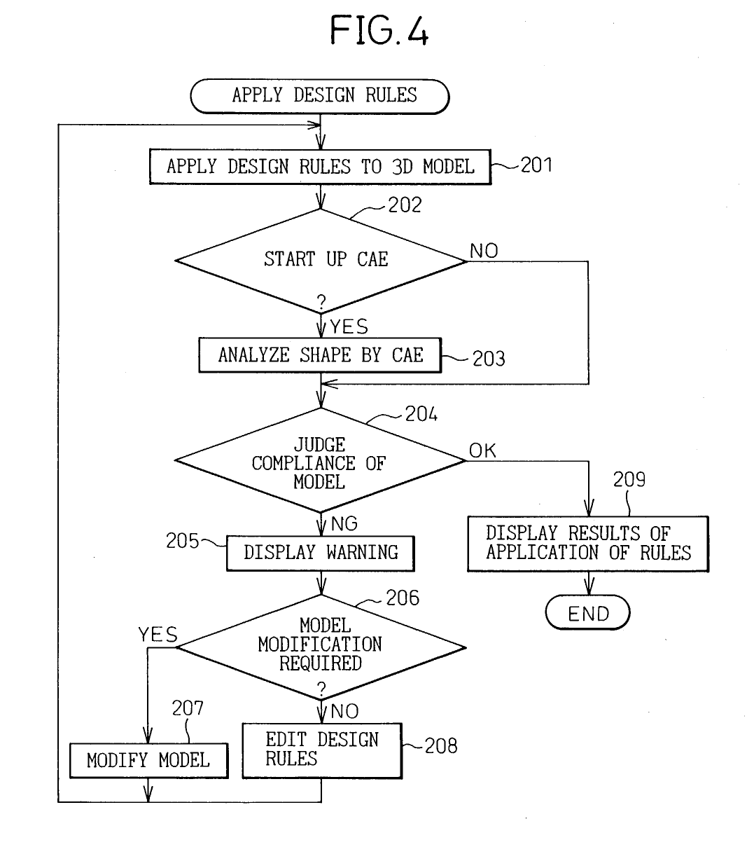

After obtaining the corresponding design rules for the three-dimensional model as explained above, the design rules are applied to the three-dimensional model in accordance with the processing of FIG. 4. FIG. 4 is a flow chart of the flow of operations of the computer 12 based on an input operation to the input unit 11.

At step 201, the design rules obtained (design rules obtained at step 106 of FIG. 3) are applied to the three-dimensional model in question (three-dimensional model read in at step 101 of FIG. 3).

Next, at step 202, it is judged if the CAE software has to be started up at the time of application of the corresponding design rules. When applying the design rule for B4 (resonance frequency when constraining flange) among the characterizing quantities of B1 to B4, it is judged YES at step 202 and shape analysis is performed by the CAE software at step 203. In practice, in CAE, constraint of the shape is specified for the bottom surface of the flange based on the results of extraction of the characterizing quantities in the processing of FIG. 3 and the shape analysis data and the inherent value of the vibration at the time of constraining the flange is analyzed (first to sixth orders or so). Further, the results of the analysis are displayed on the display unit 13.

Next, at step 204, it is judged if the three-dimensional model complies with the design rules in accordance with the results of application of the rules as explained above. When there is something violating a design rule, the routine proceeds to step 205, where the content of the rule violation is displayed on the display unit 13 and the worker is warned.

Next, at step 206, it is confirmed with the worker whether to make a modification to the three-dimensional model having the rule violation. If the worker replies to make a modification, the model is modified at step 207, then the routine returns to step 201. As a result of this, the design rules are applied again to the modified three-dimensional model and compliance is judged. By adding this model modification function, the application of the design rules becomes more reliable and it is possible to provide a three-dimensional model with high quality and without error.

However, there may also be a case where a worker deliberately design a three-dimensional model in violation of an existing design rule. In this case, the result of judgement at step 206 is NO and the routine proceeds to step 208. At step 208, under the authorization of the worker, the design rules of the design rule database 23 are modified, added to, deleted from, or otherwise edited. Due to this, it becomes possible to keep the design rules in the design rule database 23 up to date at all times. Note that it is also possible to add conditions prohibiting the act of editing of design rules according to the level of knowledge of the worker (designer). For example, it is possible to prompt the worker to input his or her years of experience or past record etc. into the CAD apparatus 10 and prohibit editing of the design rules when the years of experience fail to reach a predetermined number of years or the past experience is not sufficient.

Further, when it is judged that the three-dimensional model is suitable (OK), the routine proceeds to step 209. At step 209, even if there is no rule violation, the corresponding design rules and the results of application of the rules to the three-dimensional model are displayed on the display unit 13. In this case, it is possible to change the content of the display in stepwise stages in accordance with the level of knowledge of the worker (designer). For example, it is possible to prompt the worker to input his or her years of experience or past record etc. into the CAD apparatus 10 and display more the shorter the years of experience or the less the past experience. In practice, the content of display is changed in stepwise stages in accordance with the years of experience from display of all rules to display of no rules. Of course, it is also possible for the worker himself or herself to designate the content of display without regard as to the years of experience. Further, it is also possible to display supplementary explanations in addition to the design rules.

By deliberately displaying design rules complied with, an effect of educating the worker can be expected. That is, even if there is no rule violation in the three-dimensional model, this could happen. In such a case, by displaying or outputting the design rules, they can be reliably instilled in the habits of the worker (designer). Due to this, it is possible to propagate and pass on design rules to workers (designers) with low levels of knowledge.

According to the present embodiment explained above, the following effects are obtained:

(1) Even if the three-dimensional model is not given attribute information (value, name, parameters, etc.) or is given unreadable attribute information, the three-dimensional model can be analyzed from the characterizing quantities. That is, when analyzing a three-dimensional model, attribute information becomes unnecessary. As a result, it becomes possible to suitably analyze a three-dimensional model without relying on the attribute information of the model and in turn to streamline design work etc.

Specifically, it is possible to apply one's own design rules to three-dimensional models prepared by other CAD systems or even data received from outside the company or similar products of other companies. Therefore, a broader effect in design work can be expected.

(2) Since a wavelet transform is used to identify the part of the three-dimensional model, attribute information is not required even when identifying the part of the three-dimensional model. Therefore, even if the part of the three-dimensional model is not given a name etc., the part of the read three-dimensional model can be identified each time. That is, so long as the three-dimensional model is comprised of a solid, wire frame, surface data, point group data, etc. having shape, the above series of analysis work can be realized.

(3) Since the characterizing quantities are extracted from information of points, lines, surfaces, or solids present on the three-dimensional model, it becomes possible to analyze the shape of the three-dimensional model using just shape information. Note that it is also possible to extract the characterizing quantities from just the point information etc. among the point, line, surface, and solid information or extract the characterizing quantities from two or more types of the information or combinations of the same.

(4) Since the characterizing quantities are extracted and the corresponding design rules are obtained automatically by a series of processing and the corresponding design rules are individually applied, even if database includes a tremendous amount of design rules (knowledge), only the necessary matters can be quickly taken out. Therefore, the time for application of the design rules can be shortened and in turn the processing when automatically issuing a warning about a three-dimensional model can be speeded up. Further, in this case, no time is required for the worker (designer) to specify each location of application of a design rule or matter for application and the time required for design or development can be shortened.

(5) Since after application of the rules to the three-dimensional model, the suitable design rules displayed or output changed in stepwise stages in accordance with the level of knowledge of the worker each time, even a worker with a low level of knowledge can learn the design rules from many display and output.

(6) Since CAE software is started in accordance with need for the design rules to be applied each time and the results of analysis of the CAE software are referred to so as to judge the compliance of the three-dimensional model, it becomes possible to apply more diverse and varied design rules to a three-dimensional model.

As a means for recognizing a three-dimensional model as a whole without using attribute information, it is also possible to use a Fourier transform or another means instead of a wavelet transform. Further, the part can be identified in accordance with the results of the Fourier transform.

The means of extraction of characterizing quantities and the means of application of design rules explained above can also be applied at the design stage. In this case, it is possible to view or refer to design rules and display details of warnings while designing a part.

While the invention has been described with reference to specific embodiments chosen for purpose of illustration, it should be apparent that numerous modifications could be made thereto by those skilled in the art without departing from the basic concept and scope of the invention.

What is claimed is

1. A three-dimensional modeling system comprising:
a knowledge base to define in advance characterizing quantities of a geometric shape forming a three-dimensional model and prescribing knowledge information individually for those characterizing quantities,
a characterizing quantity extracting unit to extract characterizing quantities included in a three-dimensional model of a part, and
a knowledge base applying unit to apply the knowledge information of the knowledge base to the extracted characterizing quantities and judging if the three-dimensional model complies with that knowledge information.

2. A three-dimensional modeling system as set forth in claim 1, wherein said characterizing quantity extracting unit extracts said characterizing quantities from at least point information present on the three-dimensional model.

3. A three-dimensional modeling system as set forth in claim 1, wherein said characterizing quantity extracting unit extracts said characterizing quantities from information of points, lines, surfaces, and solids on the three-dimensional model or combinations of the same.

4. A three-dimensional modeling system as set forth in claim 1, wherein said knowledge base applying unit obtains knowledge information for the extracted characterizing quantities from the knowledge base and applies that knowledge information individually to the three-dimensional model.

5. A three-dimensional modeling system as set forth in claim 3, wherein when said knowledge base applying means judges that the three-dimensional model does not comply with the knowledge information in said knowledge base, it displays or outputs the specific content of the noncomplying location and warning information.

6. A three-dimensional modeling system as set forth in claim 1, wherein, when said knowledge base applying unit judges that the three-dimensional model complies with the knowledge information in the knowledge base, it displays or outputs the content of the suitable knowledge information changed in stepwise stages in accordance with the level of knowledge of the worker at each instance.

7. A three-dimensional modeling system as set forth in claim 1, which starts up another shape analysis software, if necessary,,regarding the knowledge information to be applied on each occasion and judges the compliance of the three-dimensional model with reference to the results of analysis of that shape analysis software.

8. A three-dimensional modeling system comprising:
a knowledge base to define in advance characterizing quantities of a geometric shape forming a three-dimensional model and prescribing knowledge information individually for those characterizing quantities,
a part identifying unit to recognize a three-dimensional model as a whole without using attribute information and identifying a corresponding part,
a characterizing quantity extracting unit to extract characterizing quantities included in the three-dimensional model for the identified part, and
a knowledge base applying unit to apply the knowledge information of the knowledge base to the extracted characterizing quantities and judging if the three-dimensional model complies with that knowledge information.

9. A three-dimensional modeling system as set forth in claim 8, wherein said characterizing quantity extracting unit extracts said characterizing quantities from at least point information present on the three-dimensional model.

10. A three-dimensional modeling system as set forth in claim 8, wherein said characterizing quantity extracting unit extracts said characterizing quantities from information of points, lines, surfaces, and solids on the three-dimensional model or combinations of the same.

11. A three-dimensional modeling system as set forth in claim 8, wherein said part identifying unit obtains shape data of the three-dimensional model by a wavelet transform, compares the obtained shape data and a sample value preset for each part, and identifies the part of the three-dimensional model from the results of the comparison.

12. A three-dimensional modeling system as set forth in claim 8, wherein said knowledge base applying unit obtains knowledge information for the extracted characterizing quantities from the knowledge base and applies that knowledge information individually to the three-dimensional model.

13. A three-dimensional modeling system as set forth in claim 8, wherein when said knowledge base applying unit judges that the three-dimensional model does not comply with the knowledge information in said knowledge base, it displays or outputs the specific content of the noncomplying location and warning information.

14. A three-dimensional modeling system as set forth in claim 8, wherein, when said knowledge base applying unit judges that the three-dimensional model complies with the knowledge information in the knowledge base, it displays or outputs the content of the suitable knowledge information changed in stepwise stages in accordance with the level of knowledge of the worker at each instance.

15. A three-dimensional modeling system as set forth in claim 8, which starts up another shape analysis software, if necessary, regarding the knowledge information to be applied on each occasion and judges the compliance of the three-dimensional model with reference to the results of analysis of that shape analysis software.
